(19) United States
(12) Patent Application Publication
(10) Pub. No.: US 2012/0200249 A1
(43) Pub. Date: Aug. 9, 2012

(54) TWO-PHASE PERMANENT MAGNET STEP MOTOR FOR MOTION CONTROL

(75) Inventors: Ted T. Lin, Saratoga, CA (US); Richard L. Badgerow, Watsonville, CA (US)

(73) Assignee: LIN ENGINEERING, Morgan Hill, CA (US)

(21) Appl. No.: 13/022,330

(22) Filed: Feb. 7, 2011

(51) Int. Cl. H02K 37/14; H02P 8/22

(52) U.S. Cl. 318/696; 310/49.53

(57) ABSTRACT

A two-phase permanent magnet step motor comprises a permanent magnet rotor having an equal number Nr of magnetic north and south poles defining a fundamental step angle θ=90°/Nr, such that a number of steps per revolution of the rotor is 360°/θ, and a toothless hybrid stator with windings defining a number Ns of stator poles, with Ns being divisible by four and a ratio Nr/Ns=n/4, n being an odd integer. The permanent magnet rotor may comprise a set of rare-earth magnets. Preferably, Nr is at most 10 (i.e., not more than 20 rotor poles). A method of driving the step motor continuously applies successive current phases to the windings with the motor speed being controllable simply by the step pulse rate. The motor can be micro-stepped at low speeds for smooth operation.

### TECHNICAL FIELD

The present invention relates to step motors having permanent magnet rotors and hybrid stators, and in particular to stepping motor designed for reducing noise. The invention also relates to motors used in motion control applications, where high/low speed control is required.

### BACKGROUND ART

A step motor is any motor, the rotor of which rotates in discrete angular increments when its stator windings are energized in a programmed manner. Step motors have a set of detent positions where the rotor comes to rest. Stepping involves the movement of the rotor between successive detent positions. Step motors are widely used as precision positioning devices, and consequently are designed for low-speed applications. The demand for step motors with low vibration and low noise is increasing.

A permanent magnet type of rotor has been used for the low-cost (˜$1.00 per motor), low-resolution, can-stack step motors, shown in FIG. 1. The stator 11 has only two windings 11a and 11b (designated as phase-one and phase-two coils), yet has e.g. 24 poles in each of the two phases. The doughnut-shaped windings 13 are wrapped with a mild steel shell 15, with fingers 17 brought to the center. One phase, on a transient basis will have a north side and a south side. Each side wraps around to the center of the doughnut with twelve inter-digitated fingers 17 for a total of 24 poles. These alternating north-south fingers will attract the permarient magnet rotor 21. A bonded 75% Neodymium-Iron-Boron (Nd—Fe—B) magnet material 23 has been commonly used for the permanent magnet rotor 21 in the can-stack design. This type of design doesn't work well with the high-energy magnet rotor. It can only accept a low pulse rate and thus has low speed. Additionally, it is characterized by low torque.

The hybrid step motor was invented for high step accuracy and high resolution. In FIGS. 2A and 2B, a permanent magnet rotor 25 and hybrid rotor 27 are shown. The permanent magnet rotor 25, such as for the above-described can-stack step motor, has a number of narrow permanent magnets with alternating outward facing N and S poles. To achieve any decent resolution, the individual magnets need to be very narrow and cannot provide much magnetic holding torque. Using a permanent magnet rotor in most of hybrid stator cannot produce enough torque due to the limitation of each magnet-pole width. The popular 1.8-degree stepper requires 100 magnet-poles (50 N & 50 S). On a rotor with a diameter of about 25 mm (1 inch), the magnet-pole width (not counting the gap between the poles) for the 100-pole rotor would be around 0.8 mm (0.031 inch) (=πd/100 poles). That small width cannot produce enough magnetic strength from the permanent magnet rotor.

In the hybrid rotor 27, two or more axially spaced strong magnets 31 and 33 with different outward-facing N or S poles has teeth 35, which in magnet 33 are offset by one-half pitch from those in magnet 31. This doubles the number of magnetic poles that can be created in the rotor to interact with the stator's pole teeth. The number of rotor teeth defines the number of rotor poles, and the resulting torque is much improved over the rotor 25. As seen in FIG. 3, the rotor 27 is mounted on an output shaft 33, which is supported for rotation via a pair of precision bearings 35 and 37. A laminated stator 41 has sets of coils 43 wound to define stator poles, each of which has a number of inward-facing stator pole teeth 45. A hybrid step motor, with its greater number of rotor poles, can accept a higher pulse rate yet still operate at a low speed due to the high number of steps per revolution.

FIGS. 4A and 4B show the 3-dimensional magnetic flux path for a conventional hybrid step motor. Magnetic flux 47 passes in the axial direction (FIG. 4B) resulting in a longer flux path and greater reluctance and winding inductance. Accordingly, it is limited in potential speed by the slow current rise time between successive phases. This is acceptable when the motor is simply used for accurate positioning applications, but limits its potential use in speed control applications.

U.S. Pat. No. 5,386,161 describes a 3-phase step motor combining a permanent magnet rotor with a hybrid-type stator. This motor was designed for noise reduction, while trying to keep a reasonably high resolution for positioning. In one embodiment, the motor has three stator teeth per stator pole and a fairly high number 32 (16 N and 16 S) of rotor poles for a permanent magnet type rotor. However, because of this, speed and torque are limited.

As well as 2-phase low-resolution can-stack PM step motors and the 3-phase hybrid step motors, a permanent magnet rotor has also been used in brushless DC motors. Most brushless DC motors are designed for high-speed applications. The rotor for this type of motor has a low number of magnetic poles and, because it cannot be micro-stepped, fails to run smoothly at low speed.

### SUMMARY DISCLOSURE

A 2-phase step motor in accord with the present invention comprises a permanent magnet rotor combined with a hybrid-type stator without stator teeth on the pole shoe for a wide speed range for positioning and speed control at low noise. The permanent magnet rotor has an equal number Nr of magnetic north and south poles that defines a fundamental step angle θ=90°/Nr for 360°/Nr steps per revolution. The rotor magnets may be composed of 100% sinter-type high-energy rare-earth magnet material (e.g., neodymium-iron-boron or samarium-cobalt). Although a permanent magnet rotor is used instead of a hybrid rotor, because the rotor has a low magnetic pole-count, e.g., from 2 to 20 Roles (i.e., Nr of at most 10), good torque and high speed are achieved. Preferred embodiments have 4 or 12 magnetic poles on the rotor, for 45° and 15° fundamental step angles.

The hybrid-type stator is toothless with windings defining a number Ns of stator poles, where Ns is divisible by 4 and a ratio Nr/Ns=n/4, n being an odd integer. Preferably, the motor uses a 4-pole or 8-pole stator. The wide stator pole shoe design of the new invention is capable of carrying the high magnetic flux generated by the high-energy permanent magnet from the rotor. In the case of a 12 magnet-poles rotor, 8 magnetic poles of the 12 from the rotor interact directly with the stator effectively. The rest of 4 magnet poles of the 12 always repulsed with the energized stator pole to act as a magnetic pusher to minimize the leakage flux from the energized stator. Thus, a high efficient motor is created. The magnetic flux is 2-dimensional for a low flux path and low reluctance for higher potential speed.

Because the motor can be micro-stepped, via application of varying drive current amplitudes to the stator windings, accuracy and smooth motion are still achievable while the motor can operate in speed control applications at both high and low speeds.

Specific applications include centrifuges, medical equipment, laboratory equipment, material handling, packaging, pumps, fans, printers, copiers, and any positioning, speed control devices of motion control system.

### BRIEF DESCRIPTION OF THE DRAWINGS

FIG. 1 is an exploded perspective view of a can-stack permanent magnet step motor of the prior art.

FIGS. 2A and 2B are perspective views of respective permanent magnet and hybrid type rotors.

FIG. 3 is an exploded perspective view of a conventional hybrid step motor with hybrid rotor as in FIG. 2B and hybrid-type stator with stator teeth.

FIG. 4 shows a cross-section of a conventional hybrid motor of the prior art with 3-dimensional magnetic flux path (prior art).

FIG. 5 shows a vector diagram illustrating 3-phase (bipolar) motor holding torque vectors.

FIG. 6 shows a permanent magnet rotor for use in the present invention.

FIG. 7 is an exploded perspective view of a step motor in accord with the present invention.

FIG. 8 shows a cross-section view of a 3-phase, 3.75° step motor of the prior art with a 2-phases energized flux path. Only 67% of the coils and stator poles are utilized.

FIG. 9 shows a cross-section view of a 3-phase brushless DC motor of the prior art with a 2-phases energized flux path. Again, only 67% of the coils and stator poles are utilized.

FIG. 10 shows a cross-section view of a 45° step motor according to the present invention with a 2-phases energized flux path. In contrast to the prior art flux paths in FIGS. 8 and 9, 100% of the coils and stator poles are utilized.

FIG. 11 shows a cross-section view of a 15° step motor according to the present invention with a 2-phases energized flux path. Again, 100% of the coils and stator poles are utilized.

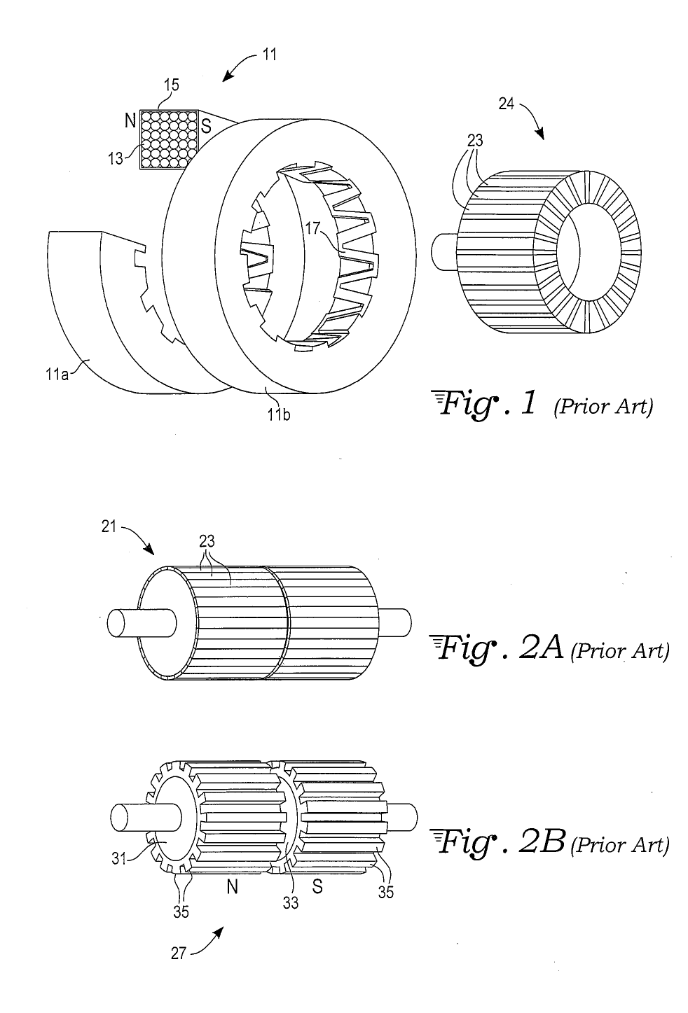

### DETAILED DESCRIPTION

With reference to FIG. 6, a permanent rotor 61 for use with step motors in accord with the present invention has very few poles. The permanent magnet rotor has an equal number Nr of magnetic north and south poles that defines a fundamental step angle θ=90°/Nr for 360°/Nr steps per revolution. For example, two north poles 63 and 65 and two south poles 64 and 66 are outward facing in the illustrated 4-poles rotor 61 for use in a 45°-step motor (Nr=2). The rotor magnets may be composed of 100% sinter-type high-energy rare-earth magnet material (e.g., neodymium-iron-boron or samarium-cobalt). Preferably Nr is at most ten (i.e., no more than 20 rotor poles in total), giving the motor good holding torque and capability for high operating speed.

The new invention is designed for low noise, low resolution (no tooth on the stator pole shoe and low number of magnet-poles rotor, such as 4-pole rotor for 45-degree stepper or 12-pole rotor for 15-degree stepper) to enable for high speed while maintaining relative high torque for motion control applications. For a 25 mm (1″) diameter rotor, the magnet-pole width of the 4-pole rotor is 39 mm (1.57″) (=2πd/4); the magnet-pole width of the 12-pole rotor is 13 mm (0.52″) (=2πd/12). These wide pole widths can produce very high magnetic strength.

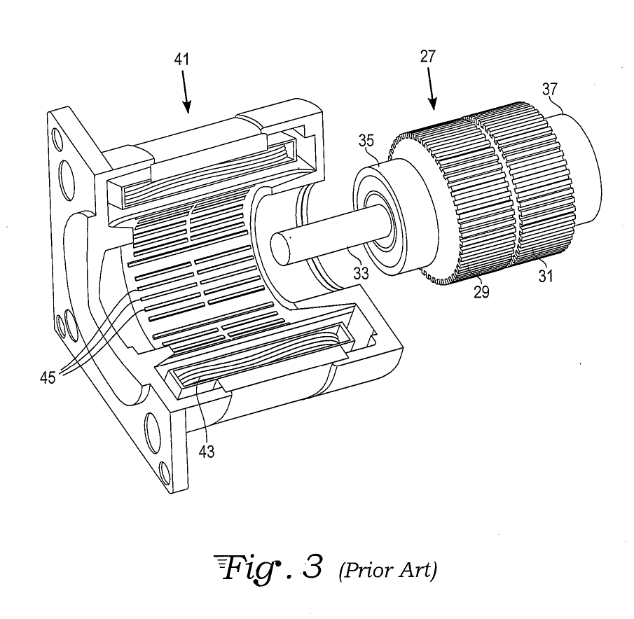

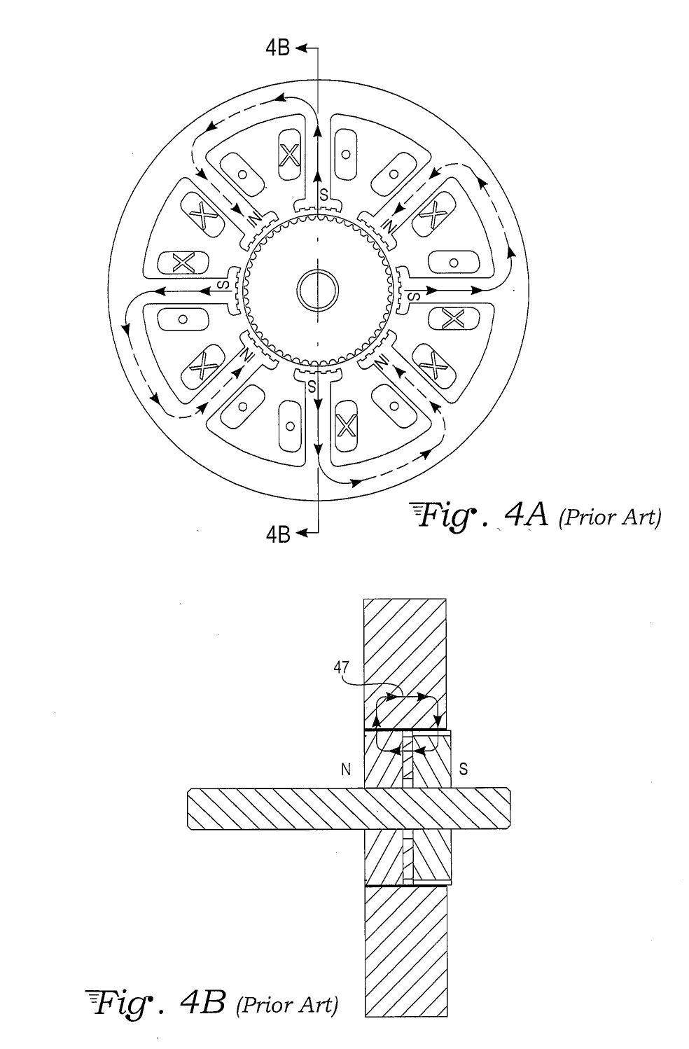

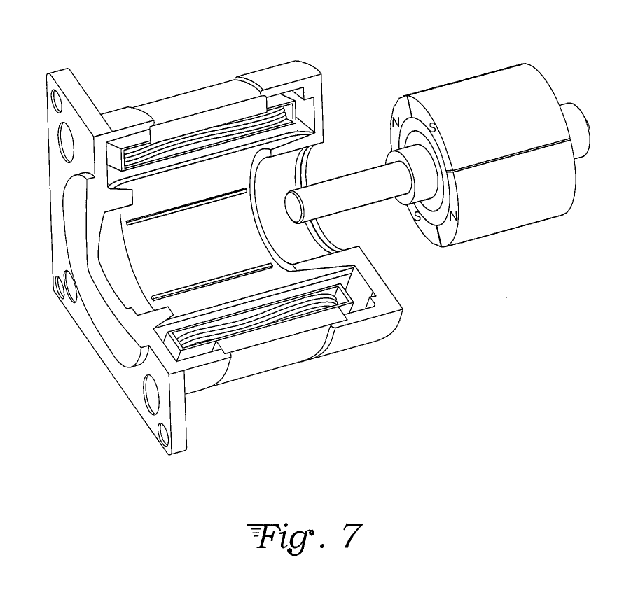

With reference to FIG. 7, a step motor in accord with the present invention combines the rotor 61 from FIG. 6 with a hybrid-type stator 71, such as that from FIG. 3 but without any stator pole teeth. That is, the hybrid-type stator for use in the present invention is toothless. Otherwise in still includes windings 73 defining a number Ns of stator poles. Ns should be divisible by 4 and the ratio Nr/Ns=n/4, where n is an odd integer. Preferably, the motor uses a 4-pole or 8-pole stator.

The following table illustrates a number of possible rotor-stator pole combinations for two-phase step motors in accord with the present invention.

| | Number of | | Number of |
|---|---|---|---|
| Fundamental | Rotor Poles | Odd | Stator Poles |
| Step Angle θ | 2 × Nr | Integer n | Ns |
| 9° | 20 | 5 | 8 |
| 10° | 18 | 9 | 4 |
| 11.25° | 16 | 1 | 32 |
| ≈12.85° | 14 | 7 | 4 |
| 15° | 12 | 3 | 8 |
| 18° | 10 | 5 | 4 |
| 22.5° | 8 | 1 | 16 |
| 30° | 6 | 3 | 4 |
| 45° | 4 | 1 | 8 |
| 90° | 2 | 1 | 4 |

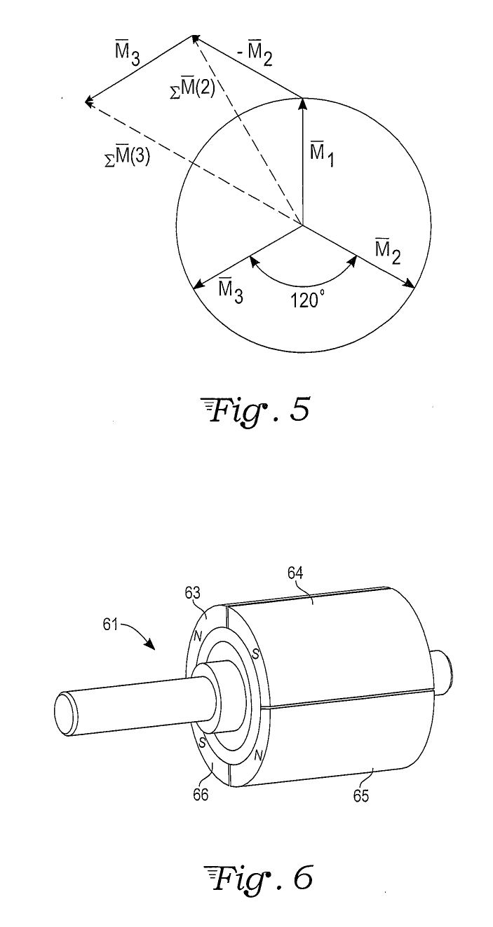

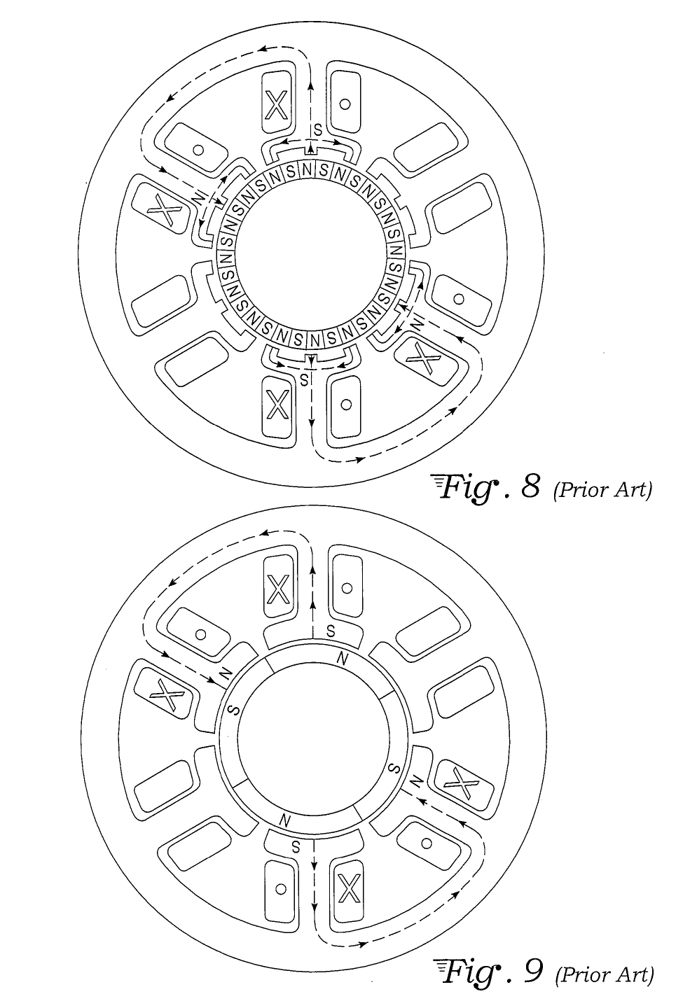

FIGS. 5, 8 and 9 illustrate aspects of torque for three-phase motors. FIG. 5, the vectors M₁, M₂ and M₃ represent the torque T per ON phase. The two-phase on case has a torque ΣM(2)=M₁−M₂=√3 T, while the three-phase on case has a torque ΣM(3)=M₁−M₂+M₃=2T. While the torque increases from one-phase ON to two-phase ON by 73%, the increase in torque when going to three-phase on is only additional 16% but increases electrical power usage by 50%. Accordingly, two-phase on is the preferred mode of operation of three-phase motors. The three phases rotate which pair of phases is energized and which is off. In FIGS. 8 and 9, the coil and stator pole utilization for a three-phase hybrid step motor and brushless DC motor at two-phase on is only 67% (only 4 of 6 stator poles are used). This is true regardless of the type of rotor.

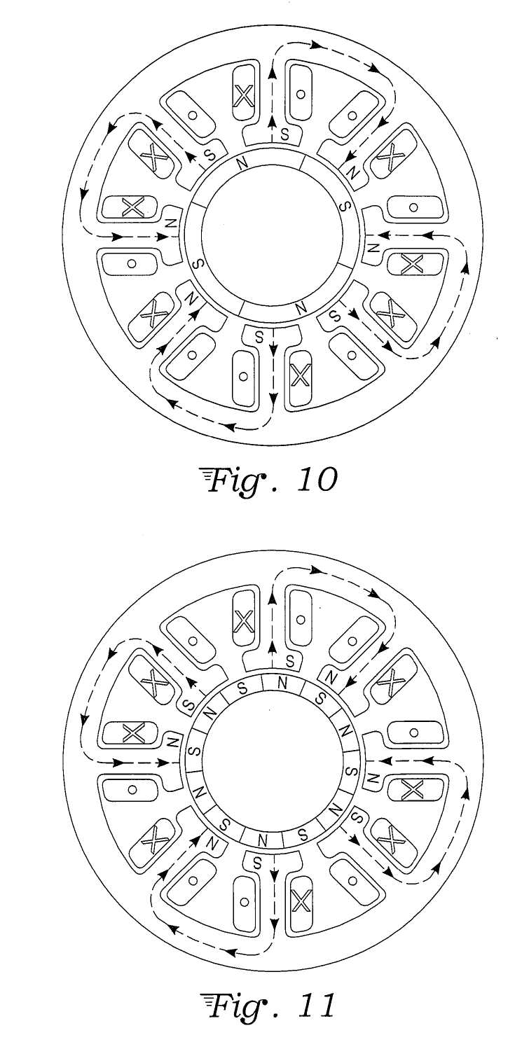

As seen in FIGS. 10 and 11, two-phase step motors in accord with the present invention, when operated at 2-phase ON, provides 100% coil and stator pole utilization. For a 45-degree step motor (FIG. 10), all four magnetic rotor poles are 100% utilized to interact with the 8 stator poles. Likewise, for a 15-degree step motor (FIG. 11), 8 of the 12 magnetic rotor poles interact directly with the stator effectively, while the remaining 4 magnetic rotor poles always repulse with the energized stator poles to act as a magnetic pusher to minimize the leakage flux from the energized stator. Thus, a high efficient motor is created.

As previously noted, in a conventional hybrid stepper the two sections of the rotor are offset by ½ of the tooth pitch, and a 3-dimensional magnetic flux path is formed and magnetic flux passes in axial direction. With the permanent magnet rotor in the present invention, the magnetic flux path is 2-dimensional, without magnetic flux in axial direction, resulting in shorter magnetic flux path and small reluctance. With the lower reluctance of the new invention, the winding inductance is smaller than the hybrid stepper. The low inductance provides fast current rise of the motor to maintain the torque at the high speed.

A method of driving such a step motor comprises continuously applying successive phases of current to the stator windings with a controlled step pulse rate. The step pulse rate defines the motor speed. The low resolution step motor of the present can operate at high speed, but also achieve smooth motion at low speed using micro-stepping. Open-loop control is used to drive the motor, simply using the step pulse rate to control the speed. Neither feedback nor a positioning sensor is needed for commutation. Thus, the new invention can be used for speed control applications currently dominated by brushless DC motors.

1. A two-phase permanent magnet step motor, comprising:
a permanent magnet rotor having an equal number Nr of magnetic north and south poles defining a fundamental step angle θ=90°/Nr, such that a number of steps per revolution of the rotor is 360°/θ; and
a toothless hybrid stator with windings defining a number Ns of stator poles, with Ns being divisible by four and a ratio Nr/Ns=n/4, n being an odd integer, a rotor speed being controllable by a step pulse rate applied to the windings.

2. A step motor as in claim 1, wherein the permanent magnet rotor comprises a set of rare-earth magnets.

3. A step motor as in claim 1, wherein Nr is at most 10 and Ns is at most 16.

4. A step motor as in claim 3, wherein the fundamental step angle θ is 15°, Nr is 6 and Ns is 8.

5. A step motor as in claim 3, wherein the fundamental step angle θ is 45°, Nr is 2 and Ns is 8.

6. A method of driving a two-phase permanent magnet step motor of a type having a permanent magnet rotor with an equal number Nr of magnetic north and south poles defining a fundamental step angle θ=90°/Nr, such that a number of steps per revolution of the rotor is 360°/θ, and a toothless hybrid stator with windings defining a number Ns of stator poles, with Ns being divisible by four and a ratio Nr/Ns=n/4, n being an odd integer, the method comprising continuously applying successive phases of current to the stator windings with a controlled step pulse rate that defines a rotor speed.

7. The method as in claim 6, wherein a series of varying current amplitude is applied within each phase to establish a smooth micro-stepping motion of the rotor.
